(19) United States
(12) Patent Application Publication
(10) Pub. No.: US 2025/0298606 A1
(43) Pub. Date: Sep. 25, 2025

(54) SOFTWARE UPDATE MECHANISM FOR TIME CRITICAL APPLICATIONS

(71) Applicant: KONE Corporation, Helsinki (FI)

(72) Inventors: Ari Kattainen, Helsinki (FI); Ferenc Staengler, Helsinki (FI); Gergely Huszak, Helsinki (FI)

(73) Assignee: KONE Corporation, Helsinki (FI)

(21) Appl. No.: 19/231,191

(22) Filed: Jun. 6, 2025

Related U.S. Application Data
(63) Continuation of application No. PCT/EP2023/050863, filed on Jan. 16, 2023.

(51) Int. Cl. G06F 8/65

(52) U.S. Cl. CPC G06F 8/65

(57) ABSTRACT

A control apparatus (120) including a control device (110); an update coordination device (111); and a memory; wherein, when the update coordination device (111) receives a new program version of a program to be updated in the control device (110), the update coordination device (111) is configured to instruct the control device (110) to conduct a hardware self-test procedure, the control device (110) is configured to conduct the hardware self-test procedure and to store a result of the hardware self-test procedure in the memory; the control device (110) is configured to check, when the update coordination device (111) initiates a software update of the program to be updated to the new program version, whether the result of the hardware self-test procedure fulfills predetermined criteria, wherein the new program version is installed and started at the control device (110) without conducting, or before completing, a further hardware self-test procedure when the check of the stored result of the hardware self-test procedure indicates that the result fulfills the predetermined criteria, when switching over to the new program version.

### BACKGROUND

### Field

The present invention relates to devices, methods, systems, and computer program products usable for controlling a software update of time critical applications or programs running, for example, in a transport or access related apparatus, such as an elevator, an escalator, a travellator, a conveyor and an automatic door.

### Background Art

The following description of background may include insights, discoveries, understandings or disclosures, or associations, together with disclosures that are not already known, but rather provided herein by the disclosure as one or more examples of embodiments. Some of examples of embodiments may be specifically pointed out below, whereas other of such contributions will be apparent from the related context.

The following meanings for the abbreviations used in this specification apply:
CPU: central processing unit
I/O: input/output
IEC: International Electrotechnical Commission
SIL: safety integrity level
SHA: secure hash algorithm

Transport or access related apparatuses, such as an elevator, an escalator, a travellator, a conveyor and an automatic door, comprise several components each provided with a processor and a memory. In case of an elevator, a processor runs, for example, an elevator component-specific application software, such as control software for door operation, floor selection, drive and brake operation, safety related operation, and the like. During elevator lifetime, new features and/or corrections of existing features are provided in the form of new software versions. Also, for example, safety regulations may change during lifetime of a component. For these reasons, it is necessary to update the application software of one or more components to be able to take advantage of the new features or corrected operation of the software.

According to the prior art, application software updating process has been traditionally performed manually on-site, e.g. on elevator site by an elevator service technician. Here, a service technician enters an elevator site, removes the elevator from normal operation, connects a programming tool such as a laptop to an elevator controller and updates the software. Afterwards the service person restores normal elevator operation and checks correct operation. This kind of update procedure is however labor-intensive, increases elevator downtime and contains a risk of human error.

Document EP 3 915 912 A1 discloses remote software update process of a transport related system, such as an elevator or escalator. In this system, a plurality of conveyor components as well as updating means are provided, which may be communicatively connected to a remote update system. The updating means may download software updates from the remote system and, upon download, schedule software updates for the conveyor components such that system downtime causes as little harm as possible to the users of the conveyor system. For example, downtime required for the software update may take place during low-traffic periods, such as during night time.

Transport or access related apparatuses, such as an elevator and the like, have also time critical software or applications running which may also subject to an update. For example, in a modern elevator system, an advanced safety system is provided which includes one or more electronic safety controllers. Electronic safety controller is, for example, a programmable safety device designed to fulfil specific safety requirements, such as in line with IEC 61508 safety standard for functional safety.

The safety controller runs a safety software, which is an example of a time-critical real-time monitoring software. By means of this, the safety controller monitors various functions and operations of the elevator system to ensure safe elevator operation. For example, the safety controller receives information from plurality of monitoring or sensor devices, such as from controllers, cameras, door contacts and/or limit switches, and determines an operational status of the elevator based on the information received. If the safety controller detects a safety-related problem, it generates a command to ensure safe state of the elevator. The safe state of the elevator may be achieved by a safety shutdown, i.e. by interrupting power supply of an elevator hoisting machine and applying the safety brakes to prevent movement of an elevator car.

However, in case a software update of the time critical application is necessary, such as of the above described monitoring software, it is necessary to either stop the operation of the respective transport or access related apparatus, or to accept that the safety of the transport or access related apparatus may be impaired, resulting from the software update and the operations to be conducted in this regard.

### SUMMARY

According to an example of an embodiment, there is provided, for example, a control device including means configured to conduct a hardware self-test procedure when receiving an instruction for conducting the hardware self-test procedure; means configured to store a result of the hardware self-test procedure in a memory; means configured to check whether the result of the hardware self-test procedure fulfills predetermined criteria; and means configured to conduct a software update of a program running in the control device (110) for installing and starting on a new program version, wherein the new program version is installed and started without conducting, or before completing, a further hardware self-test procedure when the check of the stored result of the hardware self-test procedure indicates that the result fulfills the predetermined criteria, when switching over to the new program version.

Furthermore, according to an example of an embodiment, there is provided, for example, a method including conducting a hardware self-test procedure when receiving an instruction for conducting the hardware self-test procedure; storing a result of the hardware self-test procedure in a memory; checking whether the result of the hardware self-test procedure fulfills predetermined criteria; and conducting a software update of a program running in the control device (110) for installing and starting on a new program version, wherein the new program version is installed and started without conducting, or before completing, a further hardware self-test procedure when the check of the stored result of the hardware self-test procedure indicates that the result fulfills the predetermined criteria, when switching over to the new program version.

According to further refinements, these examples may include one or more of the following features:
the predetermined criteria may comprise at least one of a determination that the result of the hardware self-test procedure is present in the memory, a determination that the result of the hardware self-test procedure is not corrupted, based on an integrity check, or a determination that a time interval from the latest hardware-self-test procedure is within a predetermined range;
in case the check of the stored result of the hardware self-test procedure indicates that the result does not fulfill the predetermined criteria, a further hardware self-test procedure may be executed when the new program version is installed and started;
the control device may be comprised in one of an electric safety controller, a drive controller or a monitoring apparatus of a transport or access related apparatus including one of an elevator, an escalator, a travellator, a conveyor and an automatic door, wherein the control device may run, as the program to be updated, a time critical application;
the memory may be a volatile memory.

According to an example of an embodiment, there is provided, for example, an update coordination device including means configured to receive a new program version of a program to be updated in a control device; means configured to instruct, when the new program version is received, the control device to conduct a hardware self-test procedure; and means configured to initiate a software update at the control device of the program to be updated to the new program version by switching over the control device to the new program version.

Furthermore, according to an example of an embodiment, there is provided, for example, an update coordination method including receiving a new program version of a program to be updated in a control device; instructing, when the new program version is received, the control device to conduct a hardware self-test procedure; and initiating a software update at the control device of the program to be updated to the new program version by switching over the control device to the new program version.

According to further refinements, these examples may include one or more of the following features:
the new program version of the program may be checked for compatibility with the control device, wherein the software update may be only initiated when the check of the compatibility is successful;
it may be checked whether the new program version of the program is indicated to be received from a trusted source and is signed, wherein the software update may be only initiated when a corresponding indication is detected;
the software update of the program to be updated may be initiated at the control device at a predetermined timing determined on the basis of an operation state of the control device;
the predetermined timing may be determined on at least one of the following: a diagnostic time interval of the control device; or an idle time slot of a time critical application running on the control device related to input filtering times, idle times of time triggered communication protocols, reciprocal verification delays, message loss delays, and message loss cycles;
the update coordination device may be part of the control device, connected to the control device as a separate entity, or a software module running on the control device.

According to an example of an embodiment, there is provided, for example, a control apparatus including a control device; an update coordination device; and a memory; wherein, when the update coordination device receives a new program version of a program to be updated in the control device, the update coordination device is configured to instruct the control device to conduct a hardware self-test procedure, the control device is configured to conduct the hardware self-test procedure and to store a result of the hardware self-test procedure in the memory; the control device is configured to check, when the update coordination device initiates a software update of the program to be updated to the new program version, whether the result of the hardware self-test procedure fulfills predetermined criteria, wherein the new program version is installed and started at the control device without conducting, or before completing, a further hardware self-test procedure when the check of the stored result of the hardware self-test procedure indicates that the result fulfills the predetermined criteria, when switching over to the new program version.

Furthermore, according to an example of an embodiment, there is provided, for example, a control method including instructing, when a new program version of a program to be updated in a control device is received, the control device to conduct a hardware self-test procedure, conducting the hardware self-test procedure and storing a result of the hardware self-test procedure in a memory, and checking, when a software update of the program to be updated to the new program version is initiated, whether the result of the hardware self-test procedure fulfills predetermined criteria, wherein the new program version is installed and started at the control device without conducting, or before completing, a further hardware self-test procedure when the check of the stored result of the hardware self-test procedure indicates that the result fulfills the predetermined criteria, when switching over to the new program version.

According to further refinements, these examples may include one or more of the following features:
the predetermined criteria may comprise at least one of a determination that the result of the hardware self-test procedure is present in the memory, and a determination that the result of the hardware self-test procedure is not corrupted, based on an integrity check, or a determination that a time interval from the latest hardware-self-test procedure is within a predetermined range;
in case the check of the stored result of the hardware self-test procedure indicates that the result does not fulfill the predetermined criteria, a further hardware self-test procedure may be executed when the new program version is installed and started;
the update coordination device may be configured to check the new program version of the program for compatibility with the control device, wherein the software update may be only initiated when the check of the compatibility is successful;
the update coordination device may be configured to check whether the new program version of the program is indicated to be received from a trusted source and is signed, wherein the software update may be only initiated when a corresponding indication is detected;
the software update of the program to be updated may be initiated at the control device at a predetermined timing determined on the basis of an operation state of the control device;
the predetermined timing may be determined on at least one of the following: a diagnostic time interval of the control device; or an idle time slot of a time critical application running on the control device related to input filtering times, idle times of time triggered communication protocols, reciprocal verification delays, message loss delays, and message loss cycles;
the update coordination device may be part of the control device, connected to the control device as a separate entity, or a software module running on the control device;
the control device may be comprised in one of an electric safety controller, a drive controller or a monitoring apparatus, wherein the control apparatus may be configured to control a transport or access related apparatus including one of an elevator, an escalator, a travellator, a conveyor and an automatic door, wherein the program to be updated is a time critical application;
the memory may be a volatile memory.

Moreover, according to an example of an embodiment, there is provided, for example, a computer program comprising instructions, which, when executed by an apparatus, cause the apparatus to perform at least any of the methods defined above.

Furthermore, according to an example of an embodiment, there is provided, for example, a method computer readable medium comprising instructions, which, when executed by an apparatus, cause the apparatus to perform at least any of the methods defined above.

In addition, according to an example of an embodiment, there is provided, for example, a computer program product for a computer, including software code portions for performing any of the methods defined above, when said product is run on the computer.

According to further refinements, the computer program product may include a computer-readable medium on which said software code portions are stored, and/or the computer program product may be directly loadable into the internal memory of the computer or transmittable via a network by means of at least one of upload, download and push procedures.

### BRIEF DESCRIPTION OF THE DRAWINGS

Some embodiments of the present invention are described below, by way of example only, with reference to the accompanying drawings, in which:

FIG. 1 shows a schematic diagram illustrating a configuration of a transport or access related apparatus, such as an elevator, according to some examples of embodiments;

FIG. 2 shows a flow chart of a processing conducted in control apparatus in a software update procedure according to some examples of embodiments;

FIG. 3 shows a flow chart of a processing conducted in a controller, such as a safety controller, in a software update procedure according to some examples of embodiments;

FIG. 4 shows a flow chart of a processing conducted in an update coordinator in a software update procedure according to some examples of embodiments; and

FIG. 5 shows a diagram of a configuration of a control apparatus according to some examples of embodiments.

### DESCRIPTION OF EMBODIMENTS

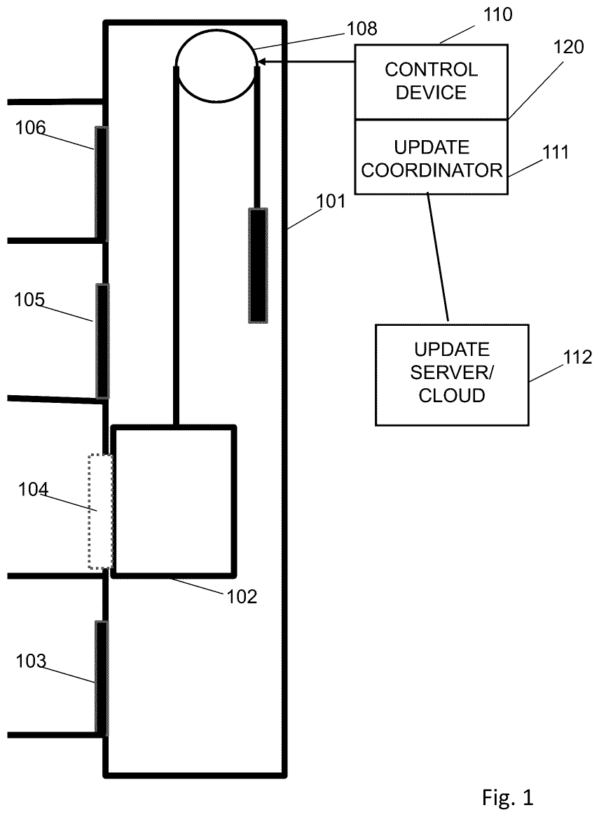

In the following, different exemplifying embodiments will be described using, as an example of a control apparatus for a transport or access related system to which embodiments may be applied, a configuration of an elevator system comprising a safety controller as depicted and explained in connection with FIG. 1. However, it is obvious for a person skilled in the art that principles of embodiments may also be applied to other kinds of transport or access related systems having different types of configurations. That is, examples of embodiments of the invention are applicable to a wide range of different kinds of control apparatuses and transport or access related systems, such as a drive controller or other controllers, an escalator system, a travellator system, a conveyor system, an automatic door and the like, where the program to be updated is running.

It is to be noted that the following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules etc. that have not been specifically mentioned.

The general elements and functions of described controllers and components of transport or access related systems, details of which also depend on the actual type of a device or function management system, are known to those skilled in the art, so that a detailed description thereof is omitted herein. However, it is to be noted that several additional devices and functions besides those described below in further detail may be employed in systems applying principles of the described embodiments.

Furthermore, elements or parts of a control device or update coordination device, a control apparatus, as well as corresponding functions as described herein, and other elements, functions or applications may be implemented by using software, e.g. by a computer program product for a computer, and/or by hardware. For executing their respective functions, correspondingly used devices, elements or functions may include several means, modules, units, components, etc. (not shown) which are required for control, processing and/or communication/signaling functionality. Such means, modules, units and components may include, for example, one or more processors or processor circuits including one or more processing portions for executing instructions and/or programs and/or for processing data, storage or memory units or means for storing instructions, programs and/or data, for serving as a work area of the processor or processing circuit and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means etc.) and the like. It is to be noted that in the present specification processing portions should not be only considered to represent physical portions of one or more processors, but may also be considered as a logical division of the referred processing tasks performed by one or more processors.

As used in this application, the term “processor” or “circuitry” may refer to hardware-only circuit implementations (such as implementations in only analog and/or digital circuitry) and/or combinations of hardware circuits and software, such as (as applicable) a combination of analog and/or digital hardware circuit(s) with software/firmware and/or any portions of hardware processor(s) with software (including digital signal processor(s)), software, and memory (ies) that work together to cause an apparatus, such as a controller, to perform various functions, and hardware circuit(s) and or processor(s), such as a microprocessor(s) or a portion of a microprocessor(s), that requires software (e.g., firmware) for operation. As a further example, as used herein, the term processor or circuitry also covers an implementation of merely a hardware circuit or processor (or multiple processors) or portion of a hardware circuit or processor and its (or their) accompanying software and/or firmware.

As used herein, “at least one of the following: ” and “at least one of” and similar wording, where the list of two or more elements are joined by “and” or “or”, mean at least any one of the elements, or at least any two or more of the elements, or at least all the elements.

FIG. 1 shows a schematic diagram illustrating a configuration of a transport or access related system, such as an elevator, according to some examples of embodiments.

Specifically, FIG. 1 schematically illustrates an example wherein in an elevator system a safety controller runs, as a time critical application, a program which is target of an update procedure.

The elevator system comprises an elevator shaft 101 in which an elevator car 102 moves to serve different floors. In FIG. 1, the elevator car 102 can stop in a first floor 103, second floor 104, third floor 105 and fourth floor 106. The floors may be any floor in a building and not necessarily the first and second floor of the building. The first floor 103 may be, for example, garage and the second floor 104 the ground level. A landing door can be arranged in each floor in front of the elevator car 102. In FIG. 1, the elevator comprises a drive unit such as a motor 108 configured to move the elevator car via a hoisting rope, wherein the motor 108 is controlled by an elevator control apparatus 120. This arrangement is, however, only an example.

An update coordinator 111 used for updating elevator component software may be arranged in connection to the control apparatus and/or integrated with a control device 110 to the control apparatus 120. The update coordinator 111 is communicatively connected to the elevator components, wherein it comprises or is connected to a processor and a memory.

For example, the update coordinator 111 may be a separate processing unit, or it may be a functionality added to some existing elevator control unit and/or elevator controller. In one example embodiment, the elevator system comprises elevator components, each comprising a memory and a processor running a component-specific application software. The control device 110 may be one of an elevator control unit (for example a unit receiving landing calls, calculating movement profile for elevator car service), a drive unit (for example a unit providing power signals to hoisting motor to move elevator car according to the movement profile), a safety controller (for example a unit programmable safety device fulfilling EN 61508 safety integrity level (SIL 3), a brake controller (for example a unit supplying current/interrupting current supply of electromagnets of hoisting machinery brakes to release/engage the brakes), a call giving unit (for example a unit for inputting manual service requests by the passengers), a car control panel, destination operation panel, door operator (for example a unit for opening/closing elevator doors), an elevator car position detection unit, an inspection drive unit (for example a unit for manual inspection drive), a group control unit (for example a unit for allocating service requests to different elevators), an overspeed governor unit (for example a unit for monitoring an overspeed situation of elevator car), a sensor measuring an operational parameter of the elevator (for example safety contact, temperature sensor, camera), voice intercom device, and the like.

In the following example, the control device 110 is assumed to include the safety controller running a time critical software according to SIL 3 which is to be updated.

The elevator system comprises, for example, a plurality of monitoring devices or sensors (not shown in FIG. 1) which are configured to collect safety-related information of the elevator system. The electronic safety controller 110 running a safety software is configured to receive the safety-related information, to determine an operational status of the elevator system based on the information received, and to generate a command to ensure safe state of the conveyor system, if a safety-related problem was detected (for example an emergency stop of the cabin 102, or the like).

It is to be noted that the elevator components, such as the control device 110, can be communicatively connected to the update coordinator 111, e.g. via a serial data bus, such as CAN bus, LAN bus or Ethernet.

Basically, for updating software of components of the transport or access system, such as the elevator system, a remote update system 112 for sending the and/or establishing the updated software and/or updated software components is used. The update coordinator 111 can be configured to download an update software from the remote update system 112 by using a transfer protocol accepted between the updating means and the remote update system, for example TCP/IP.

The remote update system 112 comprises, for example, a remote computing device, such as a server, or a cloud service. At least one communication channel is arranged between the transport or access related system, in particular the update coordinator 111 thereof, and the remote update system 112. For example, when a new software version is available, the update coordinator 111 downloads a software update from the remote update system 112 via the at least one communication channel based on request from the remote update system and/or based on a request from the transport or access related system. For example, the remote update system 112 can inform the update coordinator 111 about new software updates. For example, the update coordinator 111 can request information about the software updates from the remote update system 112 and request or select a specific update.

The transport or access related system software, such as the update coordinator 111, may perform the download of new software versions as a background download and/or without affecting the operation of the transport or access related system. Thus, interruptions in data communication or slow transfer speeds do not cause interruption to the operation of components of the transport or access related system. When the transport or access related system starts to receive data, it stores it to a memory and continues to transfer data as long as the transfer of the update data is complete. If the transfer is interrupted, it can be continued when the required systems are operational and/or e.g. when operation of the communication channel can be resumed. When the whole software has been transferred, the update, i.e. installation of the software update, can be started at a desired moment. In some cases, the installation time or moment can be selected e.g. so that the interruption of operation for users can be kept minimal, e.g. at a certain time, e.g. night.

For example, the remote update system 112 is configured to send the update software data on segments or blocks, for example in the form of a chained list. Each segment or block is provided with an identification. The update coordinator 111 is configured to reassemble the downloaded update software from the segments or blocks, on the basis of the respective identifications.

The update coordinator 111 is configured to schedule a software update of an elevator component upon verification of the integrity of the downloaded update software, such that all segments/blocks have been downloaded. This can mean that, upon communication interrupt or missing some segments or blocks, the updating means can resume the software download without need of reloading the entire software. This can also be used to verify that the software has been transferred and stored to the memory successfully, e.g. without any errors.

Furthermore, the update coordinator 111 can request the remote update system 112 to resend one or more identified data segments or blocks in case of failure of verification of the integrity. This can mean that, upon communication interrupt or missing some segments or blocks, the update coordinator 111 can resume the software download without need of reloading the entire software.

The connection between the update coordinator 111 and the remote update system 112 may be any suitable physical media comprising e.g. a data cable and/or a wireless network, such as a cellular network.

The software to be updated, such as the application software of the control device 110, comprises e.g. an installation key, such as an encryption key, associated with an elevator component-specific counterpart such as the control device 110, so that the application software may be installed successfully only in the elevator component associated with the respective installation key, i.e. the control device 110 (the safety controller).

However, a software update of the time critical application, such as the safety application program running at the safety controller 110, is more difficult as it is necessary to stop the operation of the whole system (elevator system) or to accept that the safety of the elevator may be impaired, resulting e.g. from a re-start of the control device after the software update.

Therefore, according to examples of embodiments of the present invention, a solution is provided for software updates of components where, for example, a time critical program is running, such as a monitoring application running on a programmable electronic safety controller. Specifically, according to examples of embodiments, the updates are carried out on-the-fly, without the need to remove the elevator system from service. By means of the proposed measures, it is possible that the downtime of the updated component, such as of the elevator safety system, is eliminated or at least significantly reduced.

Specifically, according to examples of embodiments, a power-on software update procedure is executed which relies on a preceding (the latest) hardware self-test result of the component to be updated, i.e. the safety controller 110. The hardware self-test result being referred to is verified by a suitable integrity check, such as by using a hash function, like SHA 256, for example.

For example, according to examples of embodiments, the update coordinator 111 may receive a software update from an update provider (the remote update system 112) via a remote communication link. Then, the component to be updated, here the safety controller 110, conducts a hardware self-test. This is triggered, for example, by a corresponding command or instruction from the update coordinator 111 receiving the software update. The test result of the hardware self-test is recorded in a memory of the safety controller. It is to be noted that the instruction for triggering the hardware self-test can be received from an internal source (i.e. automated self-test) or an external source.

The hardware self-test conducted by the safety controller 110 comprises, for example, a plurality of tests, such as a check of the functionality of a CPU of the controller, a periphery of the CPU, a check of the functionality of memory elements, such as a read-only memory (ROM) and a random access memory (RAM), e.g. by using a checksum, a check of peripheral elements, such as storing devices and the like. Depending on the amount of components to be checked and the steps to be conducted, the hardware self-test requires a certain amount of time.

Furthermore, according to examples of embodiments, the new software version received by the update coordinator has to be a trusted, signed software. For example, principles of secure booting mechanism are applied to guarantee absolute integrity (corruption) and non-repudiation (digital signature). For example, according to examples of embodiments, the signed software contains trusted information about designated hardware, wherein the software is able to identify hardware. On the other hand, the currently running software is able to discard incompatible new software packages sent to it.

According to examples of embodiments, the update coordinator 111 conducts a compatibility test so as to ensure that the new software version is compatible and able to run at the designated component. When the update coordinator 111 is, for example, a software module located in the memory of the safety controller 110, compatibility is tested in parallel to the operation using the former version of the program, i.e. without affecting the current operation.

After the above described measures, at least after the hardware self-test, the update coordinator 111 performs a software switchover to the new software version. In this connection, it is checked whether the hardware self-test result being stored fulfills predefined criteria. If this is the case, a fast restart of the software is conducted by skipping hardware-self test, i.e. without conducting or before completing a (further) hardware self-test, during the restart process of the new software version. This means, the safety controller works with the new software version without interruption of power supply of the safety controller. That is, even if a new hardware self-test is (already) started in the background, it is not necessary to wait for completion before launching the new software version. Hence, the launch of the new software version can be accelerated. The same applies, of course, when the launch of the new software version is made without conducting, i.e. starting a further hardware self-test.

That is, according to examples of embodiments, the switchover time to the new software version is reduced by referring the latest hardware self-test result wherein a suitable integrity check method is employed.

Furthermore, according to examples of embodiments, the hardware self-test result is stored in a memory. The hardware self-test result is present in the memory when the power is not interrupted during the switchover. Thus, the new software assumes that the hardware be fully operational without the need to wait for the first self-test to complete. This allows normal operation right after switchover to the new software.

According to examples of embodiments, the memory is a volatile memory. In this case, when a power interruption occurs, the volatile memory content would be lost or at least corrupted. This would trigger a full hardware self-test.

According to further examples of embodiments, the memory is a non-volatile memory, such as an EEPROM. In this case means for counting time since the latest hardware self-test (e.g. a timer) are provided. In other words, a time since the latest self-test procedure is measured or counted also during power down. That is, it is to ensured that there is either no power cycle or that the time during a power down is kept tracked, i.e.

to keep track of the time interval. For example, it has to be determined that the measured time interval from the latest hardware-self-test procedure is within a predetermined range. If the time interval since the latest self-test procedure exceeds a predefined limit, then a new hardware self-test will be conducted. Said means for counting time since the latest hardware self-test could be e.g. a separate timer with a battery back-up.

According to examples of embodiments, the criteria to be met comprises that the hardware self-test result is present in the memory and that it is not corrupted, which can be determined by using the integrity mechanism based e.g. on a hash function.

Alternatively or additionally, information regarding the time interval from the latest hardware self-test is checked.

As described above, by means of the measures described above, a normal operation is possible right after the software switchover, without power interruption of the safety controller. Because of the fast update process, according to examples of embodiments, on-the-fly software updates can scheduled for specified timings. For example, idle time slots of the real-time safety controller software can be used. This is based, for examples, on properties of the time critical software, such as on the configuration of a safety application. Safety decisions are typically made based on cyclic operation which includes specific time delays and error resilience techniques. For example, there are electrical/mechanical filtering times required by specific input sources. Moreover, for time-triggered network solutions, the pace of the network cycle is to be considered. Furthermore, for redundant networks, there is a reciprocal verification delay. In addition, there is the possibility for a message loss caused by transmission errors (in the example of SIL, a corresponding SIL node is lost for that cycle).

According to examples of embodiments, these intervals are used for software update purposes. In detail, the timing for the software update is selected by utilizing e.g. input filtering times, idle times of time-triggered communication protocols, reciprocal verification delays, message loss delays/loss cycles. It is to be noted that these time intervals are also usable in SIL devices such as the safety controller.

Due to the short amount of time necessary to complete the update, as described above, examples of embodiments enable it that hardware diagnostic time interval limits are not exceeded, due to the fast restart capability.

Examples of embodiments are not limited to SIL-rated safety devices. Rather, as indicated above, other time-critical applications can be targeted as well, e.g. in door operators or elevator drive units, where system downtime can be minimized accordingly.

As indicated above, by means of the invention, uninterrupted or at least more continuous safety monitoring periods can be achieved, so that elevator downtime is reduced and/or more safety-related issues can be noticed.

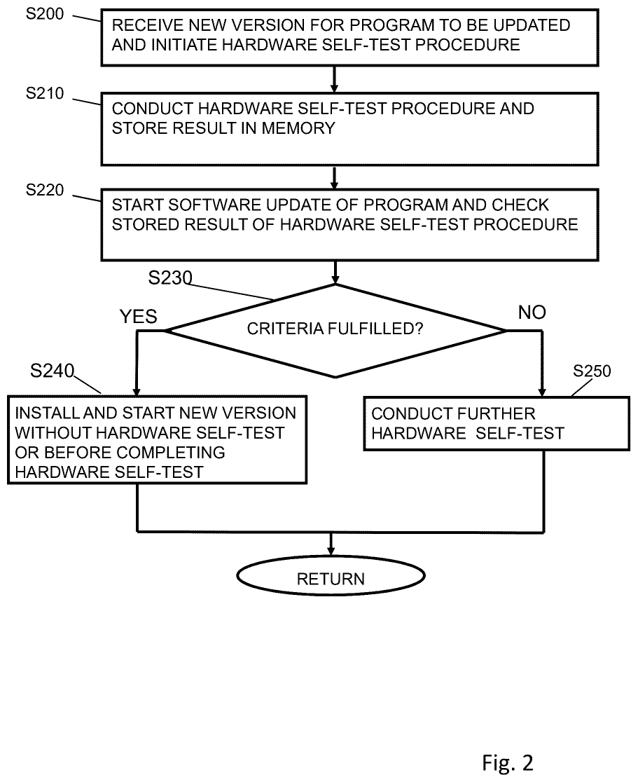

FIG. 2 shows a flow chart of a processing conducted in a control apparatus of a transport or access related system according to some examples of embodiments. Specifically, the example according to FIG. 2 is related to a procedure conducted by control apparatus 120 as shown in FIG. 1.

Specifically, it is assumed that the control apparatus 120 includes a control device 110, such as an electric safety controller or a drive controller, an update coordination device 111 and a memory. For example, the control apparatus 120 controls a transport or access related apparatus including one of an elevator, an escalator, a travellator, a conveyor and an automatic door. Moreover, according to examples of embodiments, the program to be updated is a time critical application.

The update coordination device 111 may be part of the control device 110, or it may be connected to the control device 110 as a separate entity, or it may be a software module running on the control device 110.

In S200, the update coordination device 111 receives a new program version of a program to be updated in the control device 110. The update coordination device 111 instructs the control device 110 to conduct a hardware self-test procedure.

According to examples of embodiments, the update coordination device 111 checks the new program version of the program for compatibility with the control device 110. The software update is only initiated when the check of the compatibility is successful.

Moreover, according to examples of embodiments, the update coordination device 111 checks whether the new program version of the program is indicated to be received from a trusted source and is signed. The software update is only initiated when a corresponding indication is detected.

In S210, the control device 110 conducts the instructed hardware self-test procedure and stores a result of the hardware self-test procedure in the memory.

In S220, when the update coordination device 111 initiates a software update of the program to be updated to the new program version, it is checked whether the result of the hardware self-test procedure fulfills predetermined criteria.

For example, according to examples of embodiments, the predetermined criteria comprises at least one of a determination that the result of the hardware self-test procedure is present in the memory, and a determination that the result of the hardware self-test procedure is not corrupted, which can be based on an integrity check (e.g. a hash function).

According to examples of embodiments, the software update of the program to be updated is initiated at the control device 110 at a predetermined timing determined on the basis of an operation state of the control device 110. For example, the predetermined timing is determined on at least one of the following: a diagnostic time interval of the control device 110, or an idle time slot of a time critical application running on the control device 110 related to input filtering times, idle times of time triggered communication protocols, reciprocal verification delays, message loss delays, and message loss cycles.

In S230, it is determined whether the result of the hardware self-test fulfills the predetermined criteria.

If the decision in S230 is affirmative (YES), in S240, when switching over to the new program version, the new program version is installed and started at the control device 110 without conducting, or before completing, a further hardware self-test procedure. That is, according to examples of embodiments, even if a new hardware self-test is started in the background, it is not necessary to wait for completion before launching the new software version. Hence, launch of the new software version can be accelerated. The same applies when the launch of the new software version is made without conducting, i.e. starting a further hardware self-test.

Otherwise, in case the decision in S230 is negative (NO), the control device 110 executes a further hardware self-test procedure when the new program version is installed and started.

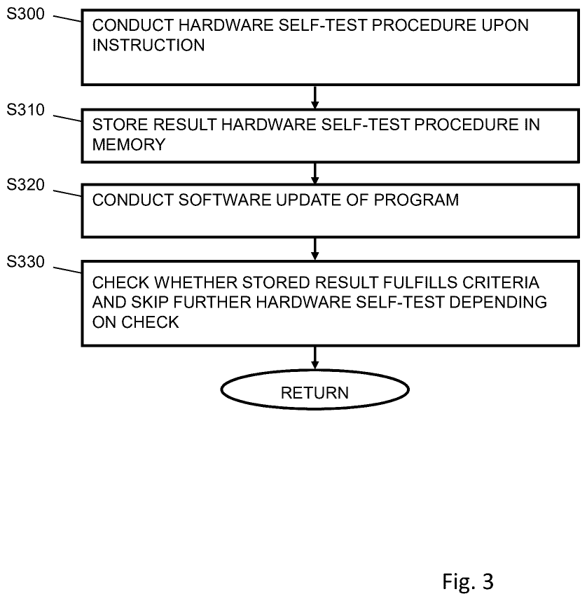

FIG. 3 shows a flow chart of a processing conducted in a control device used for a transport or access related system according to some examples of embodiments. Specifically, the example according to FIG. 3 is related to a procedure conducted by the control device 110 as shown in FIG. 1.

Specifically, it is assumed that the control device 110 is comprised, for example, in an electric safety controller, a drive controller or a monitoring apparatus. For example, the control device 110 is used for controlling a transport or access related apparatus including one of an elevator, an escalator, a travellator, a conveyor and an automatic door. Moreover, according to examples of embodiments, the program to be updated is a time critical application.

In S300, a hardware self-test procedure is conducted when an (internally or externally provided) instruction for conducting the hardware self-test procedure is received.

In S310, a result of the hardware self-test procedure is stored in a memory, for example in a volatile memory or another suitable memory.

In S320, a software update of a program running in the control device 110 is conducted for installing and starting on a new program version,

In this connection, in S330, it is checked whether the result of the hardware self-test procedure stored in the memory fulfills predetermined criteria.

For example, according to examples of embodiments, the predetermined criteria comprises at least one of a determination that the result of the hardware self-test procedure is present in the memory, and a determination that the result of the hardware self-test procedure is not corrupted, which can be based on an integrity check (e.g. a hash function).

That is, according to examples of embodiments, when the check of the stored result of the hardware self-test procedure indicates that the result fulfills the predetermined criteria, when switching over to the new program version, the new program version is installed and started without conducting, or before completing, a further hardware self-test procedure, that is, the further hardware self-test is skipped.

According to examples of embodiments, on the other hand, in case the check of the stored result of the hardware self-test procedure indicates that the result does not fulfill the predetermined criteria, a further hardware self-test procedure is executed when the new program version is installed and started.

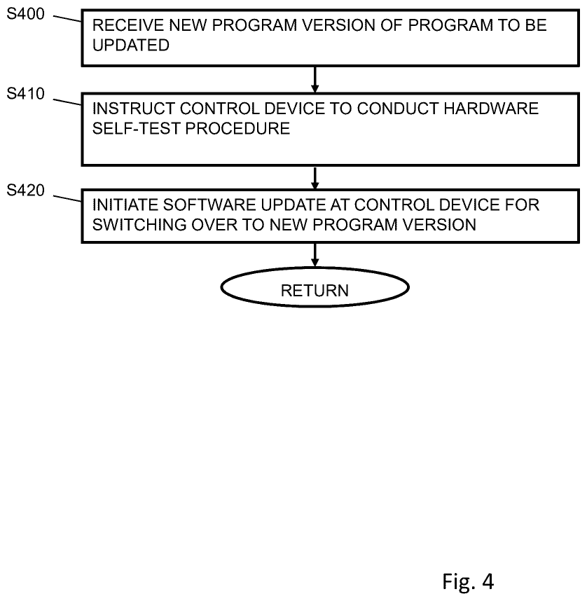

FIG. 4 shows a flow chart of a processing conducted in an update coordinator used for a transport or access related system according to some examples of embodiments. Specifically, the example according to FIG. 4 is related to a procedure conducted by the update coordinator 111 as shown in FIG. 1.

Specifically, it is assumed that the update coordinator 111 is comprised, for example, in a control apparatus 120 controlling a transport or access related apparatus including one of an elevator, an escalator, a travellator, a conveyor and an automatic door. Moreover, according to examples of embodiments, a program to be updated is a time critical application. The update coordination device 111 may be part of control device 110, or it may be connected to control device 110 as a separate entity, or it may be a software module running on control device 110.

In S400, update coordination device 111 receives a new program version of a program to be updated in a control device 110.

According to examples of embodiments, the update coordination device 111 checks the new program version of the program for compatibility with the control device 110. A software update is only initiated when the check of the compatibility is successful.

Moreover, according to examples of embodiments, the update coordination device 111 checks whether the new program version of the program is indicated to be received from a trusted source and is signed. A software update is only initiated when a corresponding indication is detected.

In S410, when the new program version is received, update coordination device 111 instructs the control device 110 to conduct a hardware self-test procedure.

In S420, the update coordination device 111 initiates a software update at the control device 110 of the program to be updated to the new program version by switching over the control device 110 to the new program version.

According to examples of embodiments, update coordination device 111 initiates the software update of the program to be updated at the control device 110 at a predetermined timing determined on the basis of an operation state of the control device 110. For example, the predetermined timing is determined on at least one of the following: a diagnostic time interval of the control device 110, or an idle time slot of a time critical application running on the control device 110 related to input filtering times, idle times of time triggered communication protocols, reciprocal verification delays, message loss delays, and message loss cycles.

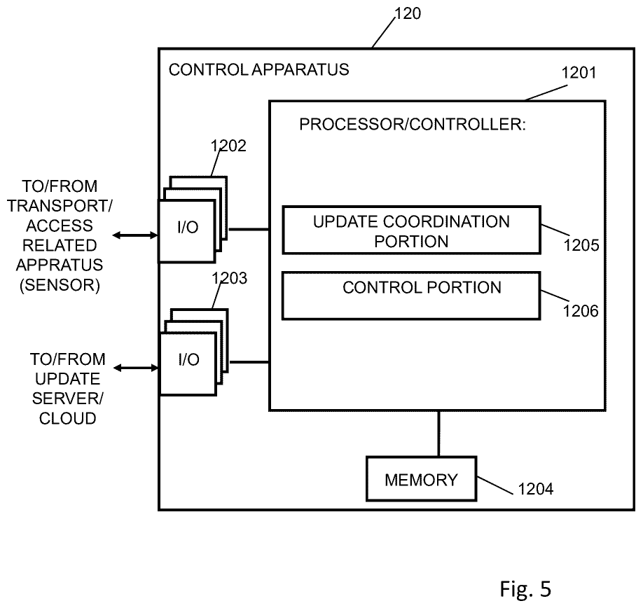

FIG. 5 shows a diagram of a configuration of a control apparatus of a transport or access related system, such as of the control apparatus 120 according to some examples of embodiments, which is configured to implement a procedure for a software update as described in connection with some of the examples of embodiments. It is to be noted that the control apparatus 120 may include further elements or functions besides those described herein below. Furthermore, even though reference is made to a device like a controller, the device or function may be also another device or function having a similar task, such as a chipset, a chip, a module, an application etc., which can also be part of a controller or attached as a separate device to a controller, or the like. It should be understood that each block and any combination thereof may be implemented by various means or their combinations, such as hardware, software, firmware, one or more processors and/or circuitry.

The control apparatus 120 shown in FIG. 5 may include a processing circuitry, a processing function, a control unit or a processor 1201, such as a CPU or the like, which is suitable for executing instructions given by programs or the like related to the control procedure. The processor 1201 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example.

Reference signs 1202 and 1203 denote input/output (I/O) units or functions (interfaces) connected to the processor or processing function 1201. The I/O units 1202 may be used for communicating with elements or functions of the transport or access related system, such as components of the elevator system to be controlled, as described in connection with FIG. 1, for example. The I/O units 1203 may be used for communicating with the remote update system 112, as described in connection with FIG. 1, for example. The I/O units 1202 and 1203 may be a combined unit including interface or communication equipment towards several elements, or may include a distributed structure with a plurality of different interfaces for different elements. Reference sign 1204 denotes a memory usable, for example, for storing data (such as the result of a hardware self-test) and programs to be executed by the processor or processing function 1201 and/or as a working storage of the processor or processing function 1201. It is to be noted that the memory 1204 may be implemented by using one or more memory portions of the same or different type of memory.

The processor or processing function 1201 is configured to execute the update control processing related to the above described procedures. In particular, the processor or processing circuitry or function 1201 includes one or more of the following sub-portions. Sub-portion 1205 is a processing portion which is usable as an update coordination portion. The portion 1205 may be configured to perform a processing according to that of FIG. 4. Furthermore, the processor or processing circuitry or function 1201 may include a sub-portion 1206 usable as a control portion. The portion 1206 may be configured to perform a processing according to that of FIG. 3.

It should be appreciated that
embodiments suitable to be implemented as software code or portions of it and being run using a processor or processing function are software code independent and can be specified using any known or future developed programming language, such as a high-level programming language, such as objective-C, C, C++, C#, Java, Python, Javascript, other scripting languages etc., or a low-level programming language, such as a machine language, or an assembler.
implementation of embodiments is hardware independent and may be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), and/or TTL (Transistor-Transistor Logic).
embodiments may be implemented as individual devices, apparatuses, units, means or functions, or in a distributed fashion, for example, one or more processors or processing functions may be used or shared in the processing, or one or more processing sections or processing portions may be used and shared in the processing, wherein one physical processor or more than one physical processor may be used for implementing one or more processing portions dedicated to specific processing as described,
a device may be implemented by a semiconductor chip, a chipset, or a (hardware) module including such chip or chipset;
embodiments may also be implemented as any combination of hardware and software, such as ASIC (Application Specific IC (Integrated Circuit)) components, FPGA (Field-programmable Gate Arrays) or CPLD (Complex Programmable Logic Device) components or DSP (Digital Signal Processor) components.
embodiments may also be implemented as computer program products, including a computer usable medium having a computer readable program code embodied therein, the computer readable program code adapted to execute a process as described in embodiments, wherein the computer usable medium may be a non-transitory medium.

Although the present invention has been described herein before with reference to particular embodiments thereof, the present invention is not limited thereto and various modifications can be made thereto.

1. A control device including means configured to conduct a hardware self-test procedure when receiving an instruction for conducting the hardware self-test procedure;
means configured to store a result of the hardware self-test procedure in a memory;
means configured to check whether the result of the hardware self-test procedure fulfills predetermined criteria; and
means configured to conduct a software update of a program running in the control device for installing and starting on a new program version,
wherein the new program version is installed and started without conducting, or before completing, a further hardware self-test procedure when the check of the stored result of the hardware self-test procedure indicates that the result fulfills the predetermined criteria, when switching over to the new program version.

2. The control device according to claim 1, wherein the predetermined criteria comprises at least one of
a determination that the result of the hardware self-test procedure is present in the memory,
a determination that the result of the hardware self-test procedure is not corrupted, based on an integrity check, or
a determination that a time interval from the latest hardware-self-test procedure is within a predetermined range.

3. The control device according to claim 1, wherein
in case the check of the stored result of the hardware self-test procedure indicates that the result does not fulfill the predetermined criteria, a further hardware self-test procedure is executed when the new program version is installed and started.

4. The control device according to claim 1, wherein
the control device is comprised in one of an electric safety controller, a drive controller or a monitoring apparatus of a transport or access related apparatus including one of an elevator, an escalator, a travellator, a conveyor and an automatic door,
wherein the control device runs, as the program to be updated, a time critical application.

5. The control device according to claim 1, wherein the memory is a volatile memory.

6. An update coordination device including
means configured to receive a new program version of a program to be updated in a control device ;
means configured to instruct, when the new program version is received, the control device to conduct a hardware self-test procedure; and
means configured to initiate a software update at the control device of the program to be updated to the new program version by switching over the control device to the new program version.

7. The update coordination device according to claim 6, further including
means configured to check the new program version of the program for compatibility with the control device, wherein the software update is only initiated when the check of the compatibility is successful.

8. The update coordination device according to claim 6, further including
means configured to check whether the new program version of the program is indicated to be received from a trusted source and is signed, wherein the software update is only initiated when a corresponding indication is detected.

9. The update coordination device according to claim 6, wherein the software update of the program to be updated is initiated at the control device at a predetermined timing determined on the basis of an operation state of the control device.

10. The update coordination device according to claim 9, wherein the predetermined timing is determined on at least one of the following:
a diagnostic time interval of the control device ; or
an idle time slot of a time critical application running on the control device related to input filtering times, idle times of time triggered communication protocols, reciprocal verification delays, message loss delays, and message loss cycles.

11. The update coordination device according to claim 6, wherein the update coordination device is part of the control device , connected to the control device as a separate entity, or a software module running on the control device.

12. A control apparatus including
a control device;
an update coordination device; and
a memory;
wherein, when the update coordination device receives a new program version of a program to be updated in the control device , the update coordination device is configured to instruct the control device to conduct a hardware self-test procedure,
the control device is configured to conduct the hardware self-test procedure and to store a result of the hardware self-test procedure in the memory;
the control device is configured to check, when the update coordination device initiates a software update of the program to be updated to the new program version,
whether the result of the hardware self-test procedure fulfills predetermined criteria, wherein the new program version is installed and started at the control device without conducting, or before completing, a further hardware self-test procedure when the check of the stored result of the hardware self-test procedure indicates that the result fulfills the predetermined criteria, when switching over to the new program version.

13. The control apparatus according to claim 12, wherein the predetermined criteria comprises at least one of
a determination that the result of the hardware self-test procedure is present in the memory,
a determination that the result of the hardware self-test procedure is not corrupted, based on an integrity check, or
a determination that a time interval from the latest hardware-self-test procedure is within a predetermined range.

14. The control apparatus according to claim 12, wherein
in case the check of the stored result of the hardware self-test procedure indicates that the result does not fulfill the predetermined criteria, the control device is configured to execute a further hardware self-test procedure when the new program version is installed and started.

15. The control apparatus according to claim 12, wherein the update coordination device is configured to check the new program version of the program for compatibility with the control device, wherein the software update is only initiated when the check of the compatibility is successful.

16. The control apparatus according to claim 12, wherein the update coordination device is configured to check whether the new program version of the program is indicated to be received from a trusted source and is signed, wherein the software update is only initiated when a corresponding indication is detected.

17. The control apparatus according to claim 12, wherein the software update of the program to be updated is initiated at the control device at a predetermined timing determined on the basis of an operation state of the control device .

18. The control apparatus according to claim 17, wherein the predetermined timing is determined on at least one of the following:
a diagnostic time interval of the control device ; or
to an idle time slot of a time critical application running on the control device related to input filtering times, idle times of time triggered communication protocols, reciprocal verification delays, message loss delays, and message loss cycles.

19. The control apparatus according to claim 12, wherein the update coordination device is part of the control device, connected to the control device as a separate entity, or a software module running on the control device.

20. The control apparatus according to claim 12, wherein
to the control device is comprised in one of an electric safety controller, a drive controller or a monitoring apparatus, wherein the control apparatus is configured to control a transport or access related apparatus including one of an elevator, an escalator, a travellator, a conveyor and an automatic door, wherein the program to be updated is a time critical application.

21. The control apparatus according to claim 12, wherein the memory is a volatile memory.

22. A control method including to conducting a hardware self-test procedure when receiving an instruction for conducting the hardware self-test procedure;
storing a result of the hardware self-test procedure in a memory;
checking whether the result of the hardware self-test procedure fulfills predetermined criteria; and
conducting a software update of a program running in the control device for installing and starting on a new program version,
wherein the new program version is installed and started without conducting, or before completing, a further hardware self-test procedure when the check of the stored result of the hardware self-test procedure indicates that the result fulfills the predetermined criteria, when switching over to the new program version.

23. The control method according to claim 22, wherein the predetermined criteria comprises at least one of
a determination that the result of the hardware self-test procedure is present in the memory,
a determination that the result of the hardware self-test procedure is not corrupted, based on an integrity check, or
a determination that a time interval from the latest hardware-self-test procedure is within a predetermined range.

24. The control method according to claim 22, further including
in case the check of the stored result of the hardware self-test procedure indicates that the result does not fulfill the predetermined criteria, executing a further hardware self-test procedure when the new program version is installed and started.

25. The control method according to claim 22, wherein
the method is executed in one of an electric safety controller a drive controller or a monitoring apparatus of a transport or access related apparatus including one of an elevator, an escalator, a travellator, a conveyor and an automatic door,
wherein the program to be updated is a time critical application.

26. The control method according to claim 22, wherein the memory is a volatile memory.

27. An update coordination method including
receiving a new program version of a program to be updated in a control device;
instructing, when the new program version is received, the control device to conduct a hardware self-test procedure; and
initiating a software update at the control device of the program to be updated to the new program version by switching over the control device to the new program version.

28. The update coordination method according to claim 27, further including
checking the new program version of the program for compatibility with the control device, wherein the software update is only initiated when the check of the compatibility is successful.

29. The update coordination method according to claim 27, further including
checking whether the new program version of the program is indicated to be received from a trusted source and is signed, wherein the software update is only initiated when a corresponding indication is detected.

30. The update coordination method according to claim 27, wherein the software update of the program to be updated is initiated at the control device at a predetermined timing determined on the basis of an operation state of the control device.

31. The update coordination method according to claim 30, wherein the predetermined timing is determined on at least one of the following:
a diagnostic time interval of the control device; or
an idle time slot of a time critical application running on the control device related to input filtering times, idle times of time triggered communication protocols, reciprocal verification delays, message loss delays, and message loss cycles.

32. The update coordination method according to claim 27, wherein the method is executed in the control device, executed in a separate entity connected to the control device, or executed by a software module running on the control device.

33. A control method including
instructing, when a new program version of a program to be updated in a control device is received, the control device to conduct a hardware self-test procedure,
conducting the hardware self-test procedure and storing a result of the hardware self-test procedure in a memory, and
checking, when a software update of the program to be updated to the new program version is initiated, whether the result of the hardware self-test procedure fulfills predetermined criteria,
wherein the new program version is installed and started at the control device without conducting, or before completing, a further hardware self-test procedure when the check of the stored result of the hardware self-test procedure indicates that the result fulfills the predetermined criteria, when switching over to the new program version.

34. The control method according to claim 33, wherein the predetermined criteria comprises at least one of
a determination that the result of the hardware self-test procedure is present in the memory,
a determination that the result of the hardware self-test procedure is not corrupted, based on an integrity check, or
a determination that a time interval from the latest hardware-self-test procedure is within a predetermined range.

35. The control method according to claim 33, further including
executing, in case the check of the stored result of the hardware self-test procedure indicates that the result does not fulfill the predetermined criteria, a further hardware self-test procedure when the new program version is installed and started.

36. The control method according to claim 33, further including checking the new program version of the program for compatibility with the control device, wherein the software update is only initiated when the check of the compatibility is successful.

37. The control method according to claim 33, further including checking whether the new program version of the program is indicated to be received from a trusted source and is signed, wherein the software update is only initiated when a corresponding indication is detected.

38. The control method according to claim 33, wherein the software update of the program to be updated is initiated at the control device at a predetermined timing determined on the basis of an operation state of the control device.

39. The control method according to claim 38, wherein the predetermined timing is determined on at least one of the following:
a diagnostic time interval of the control device ; or
an idle time slot of a time critical application running on the control device related to input filtering times, idle times of time triggered communication protocols, reciprocal verification delays, message loss delays, and message loss cycles.

40. The control method according to claim 33, wherein
the control method is executed in one of an electric safety controller, a drive controller or a monitoring apparatus, wherein the electric safety controller or a drive controller controls a transport or access related apparatus including one of an elevator, an escalator, a travellator, a conveyor and an automatic door, wherein the program to be updated is a time critical application.

41. The control method according to claim 22, wherein the memory is a volatile memory.

42. A non-transitory computer readable medium storing a computer program comprising instructions, which, when executed by an apparatus, cause the apparatus to perform the method of claim 22.

43. A non-transitory computer readable medium storing a computer program comprising instructions, which, when executed by an apparatus, cause the apparatus to perform the method of claim 27.

44. A non-transitory computer readable medium storing a computer program for a computer including software code portions for performing the method of claim 33.

45. The non-transitory computer readable medium according to claim 44, wherein
the software code portions are directly loadable into the internal memory of the computer or transmittable via a network by means of at least one of upload, download and push procedures.
